(19) United States
(12) Patent Application Publication
(10) Pub. No.: US 2024/0112039 A1
(43) Pub. Date: Apr. 4, 2024

(54) CLIENT-AGNOSTIC LEARNING AND ZERO-SHOT ADAPTATION FOR FEDERATED DOMAIN GENERALIZATION

(71) Applicant: QUALCOMM Incorporated, San Diego, CA (US)

(72) Inventors: Seunghan YANG, Incheon (KR); Seokeon CHOI, Yongin-si (KR); Hyunsin PARK, Gwangmyeon (KR); Sungha CHOI, Goyang-si (KR); Sungrack YUN, Seongnam (KR)

(21) Appl. No.: 18/238,998

(22) Filed: Aug. 28, 2023

Related U.S. Application Data
(60) Provisional application No. 63/411,034, filed on Sep. 28, 2022.

(51) Int. Cl. G06N 3/098; H04L 67/10

(52) U.S. Cl. CPC G06N 3/098; H04L 67/10

(57) ABSTRACT

Example implementations include methods, apparatuses, and computer-readable mediums of federated learning by a federated client device, comprising identifying client invariant information of a neural network for performing a machine learning (ML) task in a first domain known to a federated server. The implementations further comprising transmitting the client invariant information to the federated server, the federated server configured to generate a ML model for performing the ML task in a domain unknown to the federated server based on the client invariant information and other client invariant information of another neural network for performing the ML task in a second domain known to the federated server.

### CROSS REFERENCE TO RELATED APPLICATIONS

This application claims priority to U.S. Patent Application Ser. No. 63/411,034, by Fee et al., entitled “SYSTEMS AND METHODS FOR CLIENT-AGNOSTIC LEARNING AND ZERO-SHOT ADAPTATION FOR FEDERATED DOMAIN GENERALIZATION,” filed on Sep. 28, 2022, which is hereby incorporated by reference in its entirety.

### BACKGROUND

### Technical Field

The present disclosure relates generally to federated learning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (such as with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects, the techniques described herein relate to a federated client device, including: a memory; and a processor coupled with the memory and configured to: identify client invariant information of a neural network for performing a machine learning (ML) task in a first domain known to a federated server; and transmit the client invariant information to the federated server, the federated server configured to generate a ML model for performing the ML task in a domain unknown to the federated server based on the client invariant information and other client invariant information of another neural network for performing the ML task in a second domain known to the federated server.

In some aspects, the techniques described herein relate to a method of wireless communication by a user equipment (UE), including: identifying client invariant information of a neural network for performing a machine learning (ML) task in a first domain known to a federated server; and transmitting the client invariant information to the federated server, the federated server configured to generate a ML model for performing the ML task in a domain unknown to the federated server based on the client invariant information and other client invariant information of another neural network for performing the ML task in a second domain known to the federated server.

In some aspects, the techniques described herein relate to a federated client device, including: a memory; and a processor coupled with the memory and configured to: receive, from a federated server, a neural network for performing a machine learning task, the neural network generated by the federated server using a plurality of client invariant information received from a plurality of other neural networks associated with one or more domains known to the federated server; and generate, via the neural network, inference information in a domain unknown to the federated server based on an alpha generator added to a batch normalization layer of the neural network.

In some aspects, the techniques described herein relate to a method including: receiving, from a federated server, a neural network for performing a machine learning task, the neural network generated by the federated server using a plurality of client invariant information received from a plurality of other neural networks associated with one or more domains known to the federated server; and generating, via the neural network, inference information in a domain unknown to the federated server based on an alpha generator added to a batch normalization layer of the neural network.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, wherein dashed lines may indicate optional elements, and in which:

FIG. 1 is a diagram illustrating an example of a wireless communications system and an access network, in accordance with some aspects of the present disclosure.

FIG. 2A is a diagram illustrating an example of a first 5G/NR frame, in accordance with some aspects of the present disclosure.

FIG. 2B is a diagram illustrating an example of DL channels within a 5G/NR subframe, in accordance with some aspects of the present disclosure.

FIG. 2C is a diagram illustrating an example of a second 5G/NR frame, in accordance with some aspects of the present disclosure.

FIG. 2D is a diagram illustrating an example of UL channels within a 5G/NR subframe, in accordance with some aspects of the present disclosure.

FIG. 3 is a diagram illustrating an example of a base station and a UE in an access network, in accordance with some aspects of the present disclosure.

FIG. 4 is a diagram illustrating an example disaggregated base station architecture, in accordance with some aspects of the present disclosure.

FIG. 5 is a diagram illustrating an example of communications of a network entities and devices, in accordance with some aspects of the present disclosure.

FIG. 6 is a diagram illustrating an example of federated domain generalization (FDG) architecture, in accordance with some aspects of the present disclosure.

FIG. 7 is a diagram illustrating example communications and components of federated servers and federated client devices.

FIG. 8 is a diagram illustrating an example of client-agnostic learning with data augmentation, in accordance with some aspects of the present disclosure.

FIG. 9 is a diagram illustrating an example of an alpha generator, in accordance with some aspects of the present disclosure.

FIG. 10 is a diagram illustrating an example of a hardware implementation for a federated client employing a processing system, in accordance with some aspects of the present disclosure.

FIG. 11 is a flowchart of an example of a method of federated learning by a federated learning system.

FIG. 12 is a flowchart of an example of a method of federated learning by a federated client.

FIG. 13 is a diagram illustrating an example of a hardware implementation for a federated server employing a processing system, in accordance with some aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to a person having ordinary skill in the art that these concepts may be practiced without these specific details. In some instances, structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, among other examples (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, among other examples, whether referred to as software, firmware, middleware, microcode, hardware description language, or otherwise. As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

Accordingly, in one or more examples, the functions described may be implemented in hardware, software, or any combination thereof. If implemented in software, the functions may be stored on or encoded as one or more instructions or code on a computer-readable medium. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Federated learning (FL) refers to a distributed machine learning technique in which multiple decentralized nodes holding local data samples may train a global machine learning (ML) model without exchanging the data samples themselves between nodes to perform the training. A FL framework may include a centralized aggregation server and participating FL client devices (i.e., participants or nodes such as UEs). In one aspect or implementation, the FL framework enables the FL client devices to learn a global ML model by passing learned information to a central aggregation server or coordinator, which may be configured to communicate with the various FL devices and coordinate the learning framework. In some aspects, FL has been studied for the benefit of indirectly training a global model using distributed datasets, while ensuring users' privacy and reducing communication overhead issues.

Further, federated domain generalization (FDG) has been explored to advance FL by collaboratively learning a generalized global model from distributed source domains and directly deploying the global model to new clients in unseen domains (i.e., domains unknown to the central coordinator). However, in some aspects, the FDG implementations have exhibited unsatisfactory accuracy when building a global model with local client models from different domains while keeping data private and providing low generalizability within unseen domains. Further, many of the techniques proposed for addressing the low generalizability of FDG implementations conflict with the privacy benefits and privacy goals of federated learning.

As such, in some aspects, a federated client device may be configured to implement federated domain generalization without compromising user privacy. As described in detail herein, a federated client device (e.g., a UE) may collaboratively learn a generalized global model under the coordination of a federated server device and the global model may be used by other federated client devices associated with domains unknown to the federated server device. Accordingly, in some aspects, a federated domain system may be configured learn a global model with improved accuracy for performing machine learning tasks in unknown domains without the sharing of personally identifiable information and/or other private/confidential information by the federated client devices used to learn the global model.

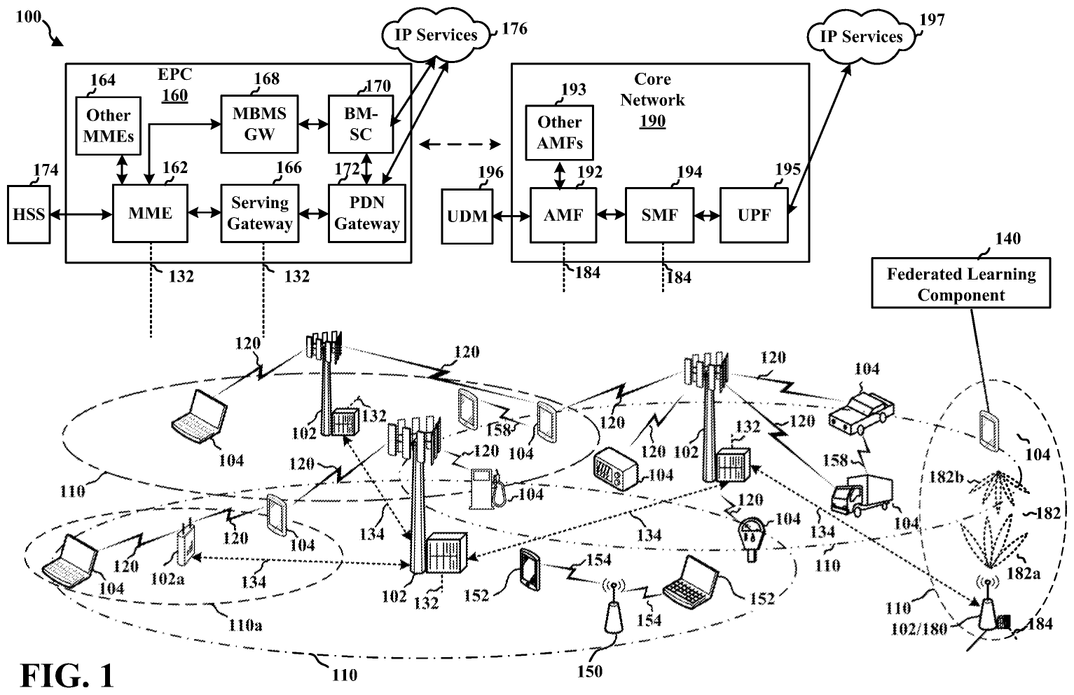

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (for example, a 5G Core (5GC)). The base stations 102 may include macrocells (high power cellular base station) or small cells (low power cellular base station). The macrocells include base stations. The small cells include femtocells, picocells, and microcells.

In some aspects, a UE 104 may be federated client device within a federated domain generalization (FDG) system. For instance, the UE 104 may include a federated learning component 140 configured to perform client-agnostic learning to determine client invariant parameters of a model, and transmit the client invariant parameters to a federated server device to be aggregated with other client invariant parameters to generate global models to be used in domains unknown to the federated server device. In addition, the federated learning component 140 may be configured to receive a global model from a federated server device. Further, in some aspects, the federated learning component 140 may be associated with a domain that is unknown to the federated server device, and apply to zero-shot adaptation to determine inferences using the global model.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (for example, an S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (for example, handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (for example, through the EPC 160 or core network 190) with each other over third backhaul links 134 (for example, X2 interface). The third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102a may have a coverage area 110a that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 or downlink (DL) (also referred to as forward link) transmissions from a base station 102 to a UE 104. The communication links 120 may use multiple-input and multiple-output (MIMO) antenna technology, including spatial multiplexing, beamforming, or transmit diversity. The communication links may be through one or more carriers. The base stations 102/UEs 104 may use spectrum up to Y MHz (for example, 5, 10, 15, 20, 100, 400 MHz, among other examples) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (for example, more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Some UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.10 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102a may operate in a licensed or an unlicensed frequency spectrum. When operating in an unlicensed frequency spectrum, the small cell 102a may employ NR and use the same 5 GHz unlicensed frequency spectrum as used by the Wi-Fi AP 150. The small cell 102a, employing NR in an unlicensed frequency spectrum, may boost coverage to or increase capacity of the access network.

A base station 102, whether a small cell 102a or a large cell (for example, macro base station), may include or be referred to as an eNB, gNodeB (gNB), or another type of base station. Some base stations, such as gNB 180 may operate in one or more frequency bands within the electromagnetic spectrum. The electromagnetic spectrum is often subdivided, based on frequency/wavelength, into various classes, bands, channels, etc. In 5G NR two initial operating bands have been identified as frequency range designations FR1 (416 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range. The base station 180 and the UE 104 may each include a plurality of antennas, such as antenna elements, antenna panels, or antenna arrays to facilitate the beamforming.

The base station 180 may transmit a beamformed signal to the UE 104 in one or more transmit directions 182a. The UE 104 may receive the beamformed signal from the base station 180 in one or more receive directions 182b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, or other IP services.

The base station 102 may include or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a satellite phone, a cellular phone, a smart phone, a session initiation protocol (SIP) phone, a laptop, a personal digital assistant (PDA), a satellite radio, a global positioning system, a multimedia device, a video device, a digital audio player (for example, MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (for example, parking meter, gas pump, toaster, vehicles, heart monitor, among other examples). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 5G NR, the concepts described herein may be applicable to other similar areas, such as 6G, LTE, LTE-A, CDMA, GSM, and other wireless technologies.

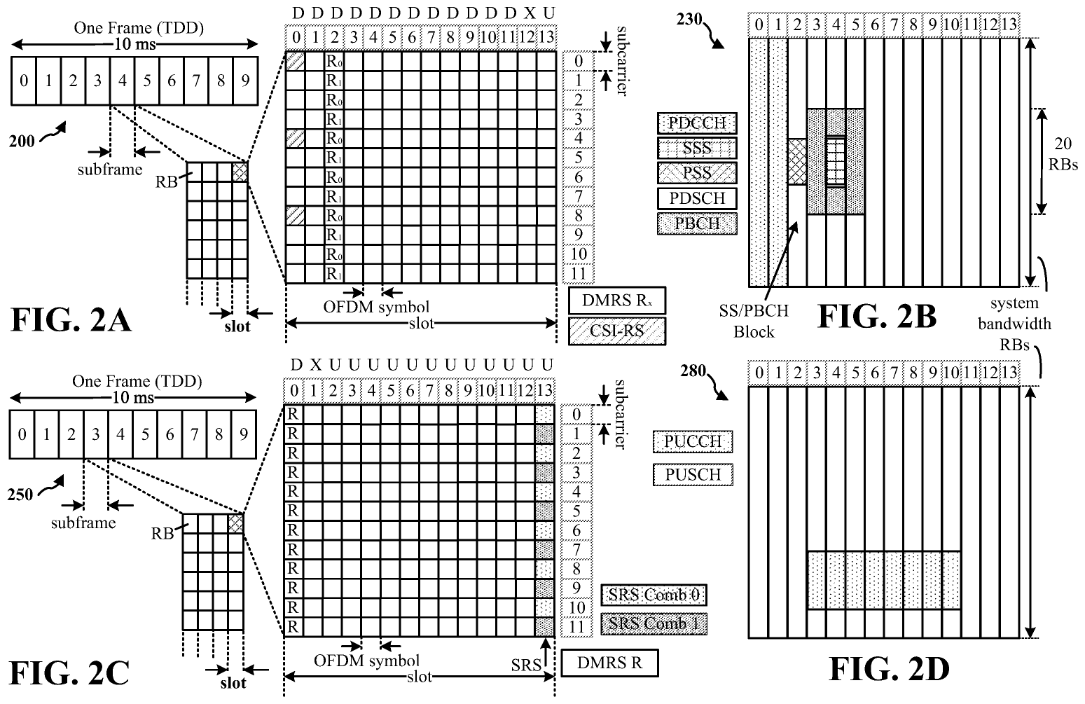

FIGS. 2A-2D include example diagrams 200, 230, 250, and 280 illustrating examples structures that may be used for wireless communication by the base station 102 and the UE 104, e.g., for 5G NR communication. FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description presented herein applies also to a 5G/NR frame structure that is TDD.

Other wireless communication technologies may have a different frame structure or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. For slot configuration 0 and numerology μ, there are 14 symbols/slot and 2μ slots/subframe. The subcarrier spacing and symbol length/duration are a function of the numerology. The subcarrier spacing may be equal to 24*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more CCE, each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), or UCI.

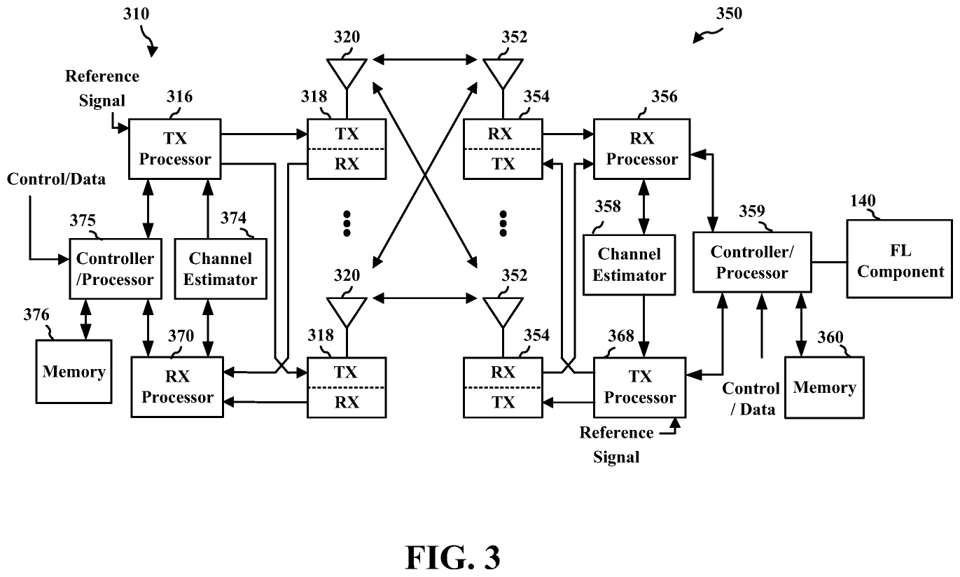

FIG. 3 is a block diagram of a base station 310 (e.g., the base station 102/180) in communication with a UE 350 (e.g., the UE 104) in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (such as MIB, SIBs), RRC connection control (such as RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (such as binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (such as a pilot) in the time or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK or NACK protocol to support HARQ operations.

Similar to the functionality described in connection with the DL transmission by the base station 310, the controller/processor 359 provides RRC layer functionality associated with system information (for example, MIB, SIBs) acquisition, RRC connections, and measurement reporting; PDCP layer functionality associated with header compression/decompression, and security (ciphering, deciphering, integrity protection, integrity verification); RLC layer functionality associated with the transfer ofupper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK or NACK protocol to support HARQ operations.

In the UE 350, at least one of the TX processor 368, the RX processor 356, and the controller/processor 359 may be configured to perform aspects in connection with the parameter set management component 140 of FIG. 1.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

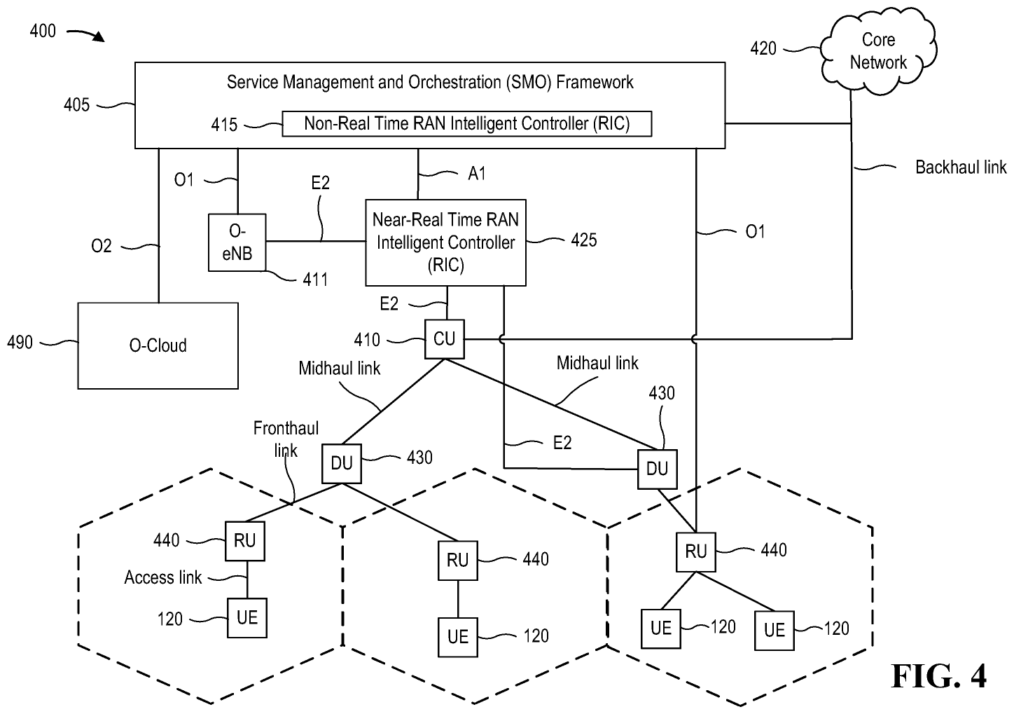

FIG. 4 shows a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUs 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function may be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random-access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 410, via an O1 interface. Additionally, in some implementations, the SMO Framework 405 can communicate directly with one or more RUs 440 via an O1 interface. The SMO Framework 405 also may include a non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the non-RT RIC 415 or the Near-RT RIC 425 may be configured to tune RAN behavior or performance. For example, the non-RT RIC 415 may monitor long-term trends and patterns for performance and employ ML models to perform corrective actions through the SMO Framework 405 (such as reconfiguration via 01) or via creation of RAN management policies (such as A1 policies).

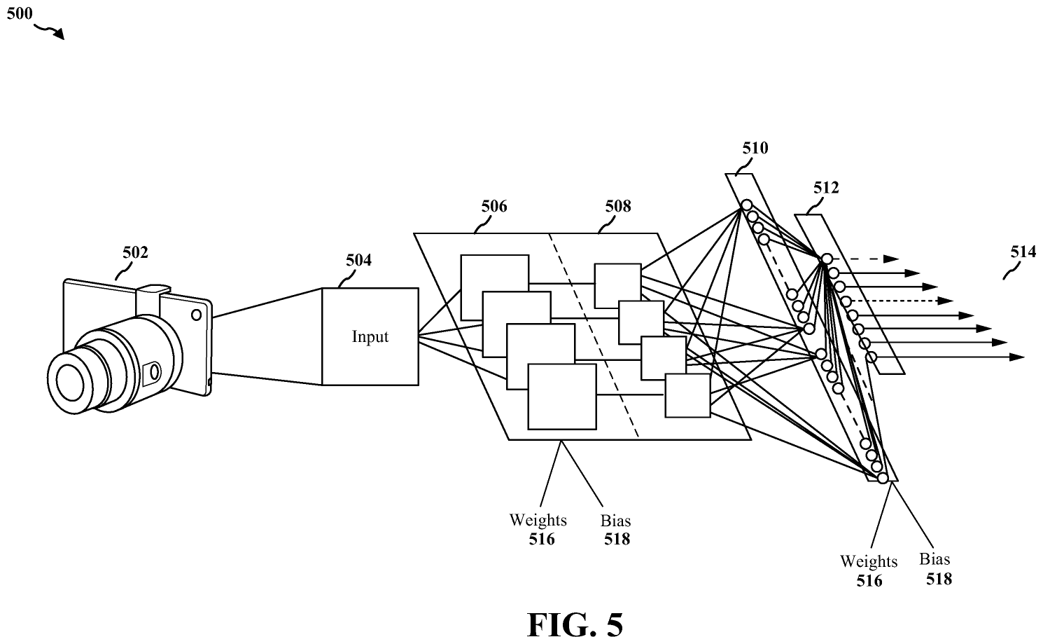

FIG. 5 illustrates an example of a neural network 500, specifically a convolutional neural network (CNN). The CNN may be designed to detect objects sensed from a video capture device 502, such as a vehicle-mounted camera, or other sensor. The neural network 500 may initially receive an input 504, for instance an image, e.g., an image of a speed limit sign having a size of 32×32 pixels (or other object or size). During a forward pass, the input image is initially passed through a convolutional layer 506 including multiple convolutional kernels (e.g., six kernels of size 5×5 pixels, or some other quantity or size) which slide over the image to detect basic patterns or features such as straight edges and corners. The images output from the convolutional layer 506 (e.g., six images of size 28×28 pixels, or some other quantity or size) are passed through an activation function such as a rectified linear unit (ReLU), and then as inputs into a subsampling layer 508 which scales down the size of the images, e.g., downsize by a factor of two (e.g., resulting in six images of size 14×14 pixels, or some other quantity or size). These downscaled images output from the subsampling layer 508 may similarly be passed through an activation function (e.g., ReLU or other function), and similarly as inputs through subsequent convolutional layers, subsampling layers, and activation functions (not shown) to detect more complex features and further scale down the image or kernel sizes. These outputs are eventually passed as inputs into a fully connected (FC) layer 510 in which each of the nodes outputs from the prior layer are connected to all of the neurons in the current layer. The output from this layer may similarly be passed through an activation function and potentially as inputs through one or more other fully connected layers (not shown). Afterwards, the outputs are passed as inputs into an output layer 512 which transforms the inputs into an output 514 such as a probability distribution (e.g., using a softmax function). The probability distribution may include a vector of confidence levels or probability estimates that the inputted image depicts a predicted feature, such as a sign or speed limit value (or another object).

During training, an ML model (e.g., a classifier) is initially created with weights 516 and bias(es) 518 respectively for different layers of neural network 500. For example, when inputs from a training image (or other source) enter a given layer of a MLP or CNN, a function of the inputs and weights, summed with the bias(es), may be transformed using an activation function before being passed to the next layer. The probability estimate resulting from the final output layer may then be applied in a loss function that measures the accuracy of the ANN, such as a cross-entropy loss function. Initially, the output of the loss function may be significantly large, indicating that the predicted values are far from the true or actual values. To reduce the value of the loss function and result in more accurate predictions, gradient descent may be applied.

In gradient descent, a gradient of the loss function may be calculated with respect to each weight of the ANN using backpropagation, with gradients being calculated for the last layer back through to the first layer of the neural network 500. Each weight may then be updated using the gradients to reduce the loss function with respect to that weight until a global minimization of the loss function is obtained, for example using stochastic gradient descent. For instance, after each weight adjustment, a subsequent iteration of the aforementioned training process may occur with the same or new training images, and if the loss function is still large (even though reduced), backpropagation may again be applied to identify the gradient of the loss function with respect to each weight. The weights may again be updated, and the process may continue to repeat until the differences between predicted values and actual values are minimized.

Network nodes, such as UEs (e.g., 104, 350) or base stations (e.g., 102, 180, 310), may train neural networks (e.g., neural network 500) using federated learning (FL). In contrast to centralized machine learning techniques where local data sets are typically all uploaded to one server, FL allows for high quality ML models to be generated without the need for aggregating the distributed data. As a result, FL is convenient for parallel processing, significantly reduces costs associated with message exchanges, and preserves data privacy.

In a FL framework, nodes such as UEs may learn a global ML model via the passing of messages between the nodes through the central coordinator. For instance, the nodes may provide weights, biases, gradients, or other ML information to a central coordinator (e.g., a base station, RSU, an edge server, etc.) which aggregates the weights, biases, gradients, or other ML information to generate a global ML model.

Further, each node in a FL environment utilizes a dataset to locally train and update a coordinated global ML model. The dataset may be a local data set that a node or device may obtain for a certain ML task (e.g., object detection, etc.). The data in a given dataset may be preloaded or may be accumulated throughout a device (e.g., UE) lifetime or otherwise during usage of the device. For example, an accumulated dataset may include recorded data that a node observes and locally stores at the node from an on-board sensor such as a camera.

The global ML model may be defined by its model architecture and model weights. An example of a model architecture is a neural network, such as the CNN described with respect to FIG. 5 or other neural network architecture, which may include multiple hidden layers, multiple neurons per layer, and synapses connecting these neurons together. The model weights are applied to data passing through the individual layers of the ML model for processing by the individual neurons.

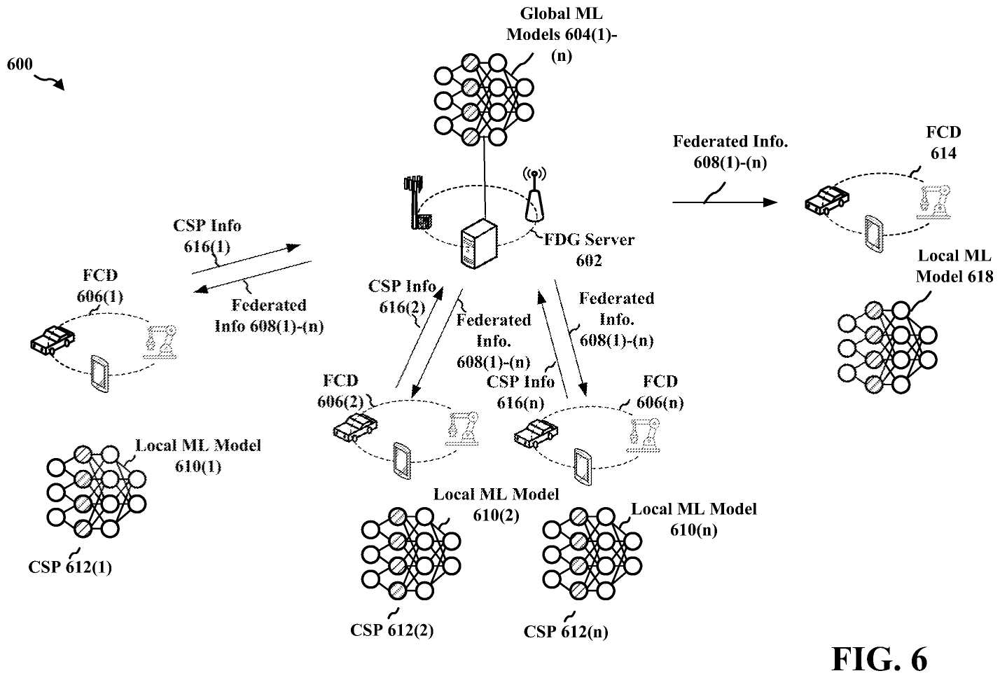

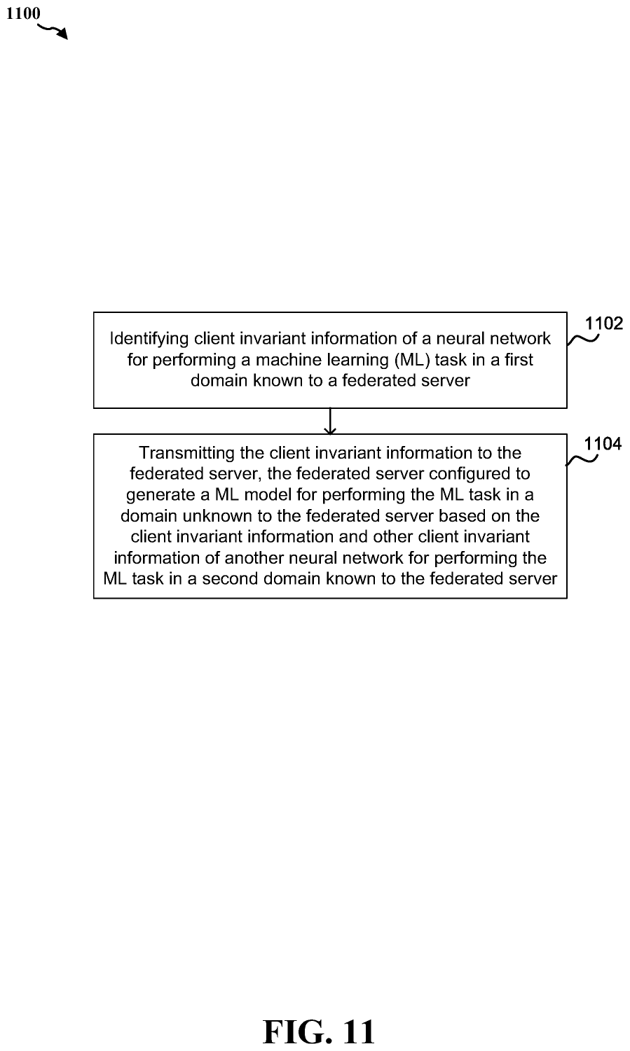

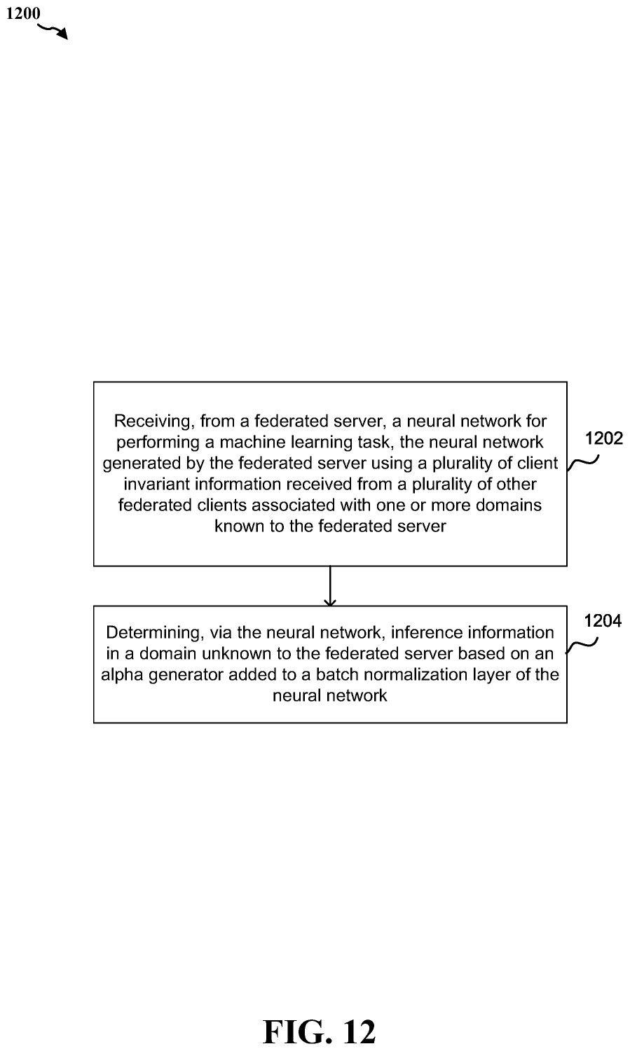

Referring to FIGS. 6-12, in some non-limiting aspects, a system 600 is configured to implement a procedure for federated domain generalization, in accordance with some aspects of the present disclosure.

FIG. 6 illustrates an example of an FDG architecture. A federated server device 602 initializes a global ML model (WoG) 604(1) (e.g., a classifier in a pre-configured ML architecture such as the CNN of FIG. 6 with random or default ML weights). The federated server device 602 broadcasts the global ML model 604 to participating devices or federated client devices 606(1)-(n) (e.g., UEs) (collectively referred to as “federated client devices 606”). Some non-limiting examples of a federated server device 602 include central coordinators (e.g., a base station, RSU, an edge server, virtualized network elements, etc.). Some non-limiting examples of federated client devices 606 include UEs, base stations, network nodes, smartphones and computing devices, Internet of Things (IoT) devices, drones, robots, process automation equipment, sensors, control devices, vehicles, transportation equipment, tactile interaction equipment, virtual and augmented reality (VR and AR) devices, industrial machines, etc.

As illustrated in FIG. 6, the federated client devices 606 may receive federated information 608 from the federated server device 602. In some aspects, the federated information 608 includes the global ML model 604. Upon receipt of the global ML model 604, the federated client devices 606 may iteratively perform a federated learning process. For instance, upon receiving the global ML model 604 (WₜG) at a given iteration t, the federated client devices 606(1)-(n) locally train the global ML model 604 as their respective local ML model 610 using a local dataset of a domain specific to the respective local ML model 610, which may be a preconfigured data set such as a training set and/or sensed data from the environment. After training, each federated client device 606 may update the weights of the local ML model 610 of the federated client device 606 until a minimization or optimization of a loss function or cost function for that model is achieved. Accordingly, each federated client devices 606 may have a different local ML model 610 due to having different weights.

Further, as described in detail herein, each federated client device 606 may identify a client shared portion 612 of the local ML model 610 that is separate from a client specific portion related to the specific domain of the federated client device 606. As described in detail herein, in some aspects, a federated client device 606 may identify its corresponding client shared portion 612 based on the batch normalization (BN) layers of the local ML model 610 of the federated client device 606. In particular, the BN layers are employed to ensure that the local ML model 610 learns client-invariant representations. Further, by isolating the client shared portions 612, the federated client devices 606 avoid negatively affecting the performance of the global ML model 604 of a federated client device 614 associated with a domain unknown to the federated server device 602 by preventing domain specific features from being included in the global ML model 604.

In addition, in some aspects, the federated client devices 606(1)-(n) may transmit client shared portion (CSP) information 616(1)-(n) including the plurality of client shared portions 612(1)-(n) to the federated server device 602. In some aspects, to reduce transmission traffic, the CSP information 616 for a particular federated client device 606 may be, for example, one or more modified weights of the client shared portions 612, one or more weights of the client shared portions 612 that changed more than a predefined threshold, and/or the multiplicative or additive delta amounts or percentages for modified weights of the client shared portions 612. Upon receipt of this CSP information 616(1)-(n), the federated server device 602 may aggregate the respective weights within the client shared portions 612 (e.g., by averaging the weights or performing some other calculation on the weights). Further, the federated server device 602 may update the first global ML model 604(1) to generate a second global ML model (Wₜ₊₁G) 604(2) including the aggregated weights and transmit federated domain (FD) information 608 including the second global ML model 604(2) to another federated client device 614 (e.g., a local ML model 610 in an unseen domain). Upon receipt of the second global ML model 604(2), the federated client device 614 may employ the global model 604 as local model 618 to perform ML tasks (e.g., generate inference information) in a domain unknown to the federated server device 602.

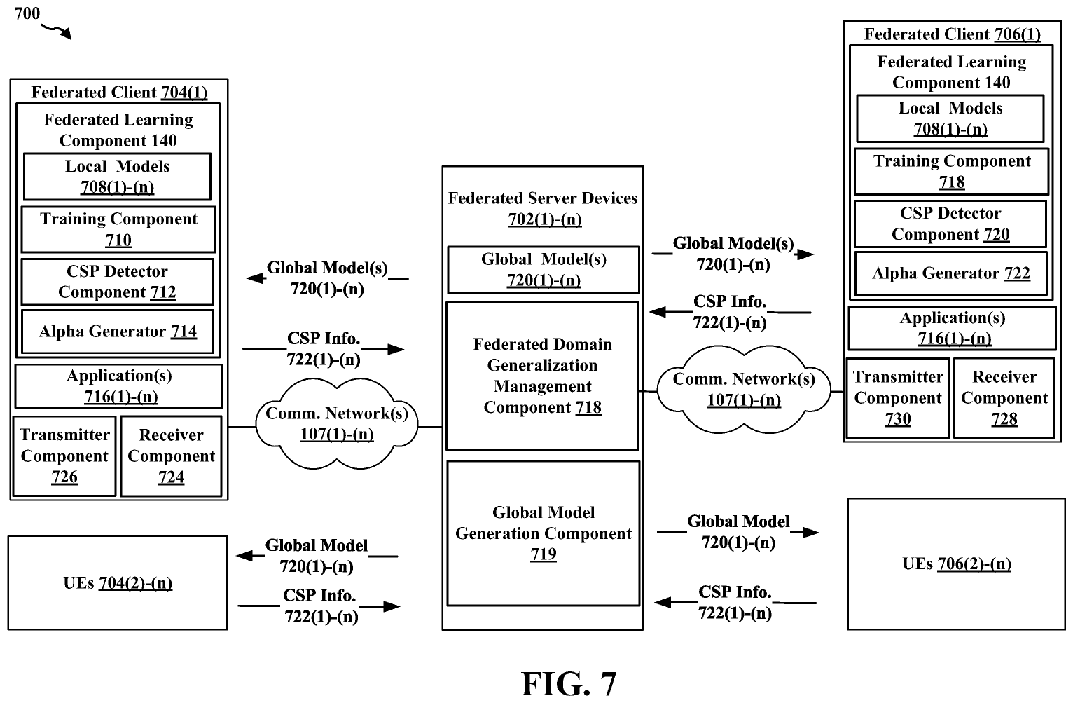

FIG. 7 is a diagram illustrating example communications and components of federated server devices and federated client devices. As illustrated in FIG. 7, the federated system 700 may include one or more federated server devices 702(1)-(n) (e.g., federated server devices 602), one or more federated client devices 704(1)-(n) (e.g., the UEs 104, the federated client devices 606(1)-(n)) in domains known to the one or more federated server devices 702, and one or more federated client devices 706(1)-(n) (e.g., the UEs 104, the federated client devices 606(1)-(n)) in domains unknown to the one or more federated server devices 702. Further, the federated system 700 may include one or more communication networks 707(1)-(n). In some implementations, the communication network(s) 707 may include one or more of a wired and/or wireless private network, personal area network, local area network, wide area network, and/or the Internet. Further, in some aspects, the federated server device 702, the federated client devices 704(1)-(n), and/or the federated client devices 706(1)-(n) may be configured to communicate via the communication network(s) 107(1)-(n).

As illustrated in FIG. 7, the federated client devices (e.g., the federated client devices 704(1)-(n) and the federated client devices 706(1)-(n)) may include one or more local models 708(1)-(n), a federated learning component 140 (e.g., a training component 710, a CSP detector component 712, and an alpha generator 714), and one or more applications 716(1)-(n). As described herein, in some aspects, a federated client device (e.g., the federated client device 704(1) and the federated client device 706(1)) may employ a local model 708(1) to perform a task. Further, in some aspects, the one or more applications 716(1)-(n) may employ the local models 708(1)-(n) to perform application tasks. For example, the application 716 may be an image processing application and employ a local model 708 to perform an image processing task (e.g., object recognition). Further, as illustrated in FIG. 7, each federated server device 702 may include a federated domain generalization management (FDGM) component 718 for managing federated domain generalization within the federated system 700 via a global model generation component 719.

As described herein, in some aspects, the federated system 700 may implement federated domain generalization. In particular, the federated server device 702 may employ data collected from the federated client devices 704(1)-(n) in domains known to the federated server devices 702(1)-(n) to create a generalized global model 720 via the global model generation component 719 and deploy the generalized global model 720 to the federated client devices 706(1)-(n). In particular, the FDGM component 718 may initialize a global model 720 and transmit the global model 720 to the federated client devices 704(1)-(n) in the domains known to the federated server device 702. Further, the training component 710 of a federated client device 704 may train the global model 720 to generate the local model 708. In some aspects, the local model 708 will include client variant layers and client invariant layers, as illustrated in FIG. 6. Further, in some aspects, the training component 710 may be configured to re-train the local model 708.

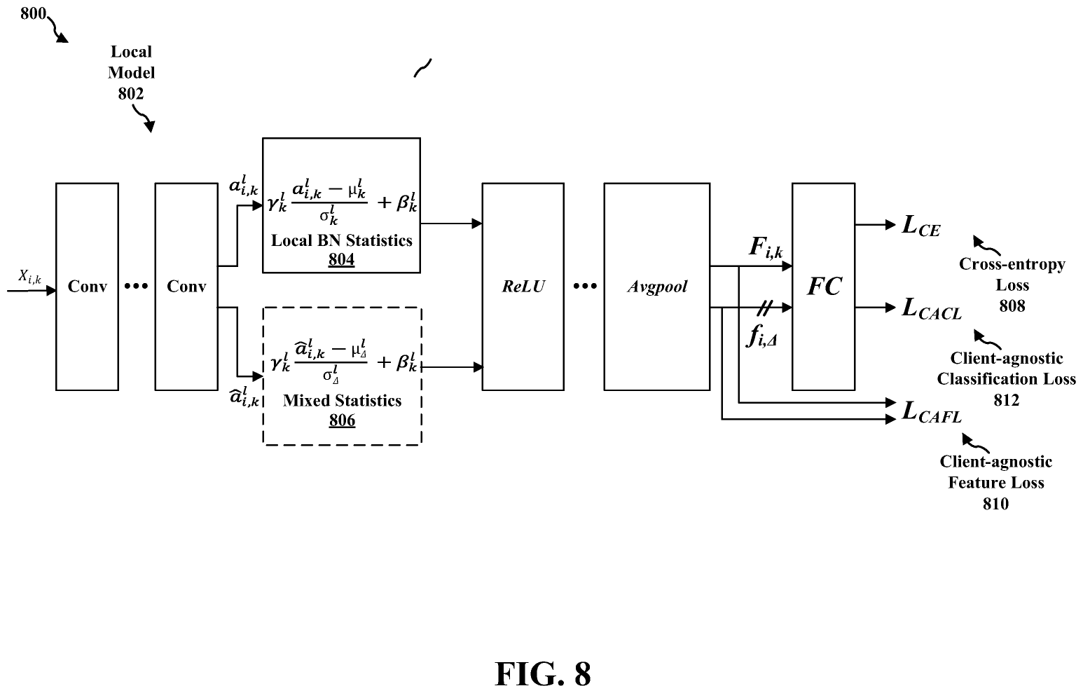

In some aspects, the client invariant layers of the federated client devices 704(1)-(n) may be overfit to the domains of the federated client device 704(1)-(n). As such, a federated client device 704 may augment local data with data distribution of other federated client devices without any privacy leakage to mitigate the overfitting issue. In particular, the training component 710 may interpolate instance statistics of sample data and global statistics associated with a plurality of other federated client devices 704. Specifically, the training component 710 may interpolate mean and variances of instance samples with global BN statistics (e.g., running means and variances) of other federated client devices 704 received from the federated server device 702. By randomly interpolating these two statistics, local data is augmented data with data distribution of other federated client devices without any privacy leakage. As described in greater detail with respect to FIG. 8, the training component 710 may employ a local training loss function, local client agnostic feature learning loss function, and client agnostic classifier learning loss function resulting from the aforementioned interpolation when training the local model 708 via batch normalization augmentation.

In response to training or re-training of a local model 708, the CSP detector component 712 may detect the client invariant layers of the local model 708. In some aspects, the CSP detector component 712 may identify the client invariant layers of the local model 708 based on batch normalization information of the local model 708. For example, the CSP detector component 712 may identify the batch normalization layers of the local model 708 as the client variant layers and the remaining layers as the client invariant information, and transmit the client invariant information layers to the federated server device 702 as CSP information 722.

Further, the CSP detector component 712 may transmit the CSP information 722 to the federated server device 702. In some aspects, the CSP information 722 may include inputs, parameters, weights, gradients, and/or scaling factor(s) associated with the client invariant layers. In addition, in some aspects, the scaling factor may be a multiplicand or a summand. Upon receipt of the CSP information 722 from the federated client devices 704, the federated server device 702 may update the global model 720. For example, the FDGM component 718 may incorporate the CSP information 722 received from the federated client devices 704 into the global model 720. Additionally, the FDGM component 718 may deploy the updated global model 720 to a federated client device 706 associated with an unknown domain. By employing the client invariant layers of the local models 708 to collaboratively train the global model 720, the federated server may avoid domain shift, which can significantly reduce performance of the global model 720 as the client variant layers being trained in view of the particular domain of the federated client device 704.

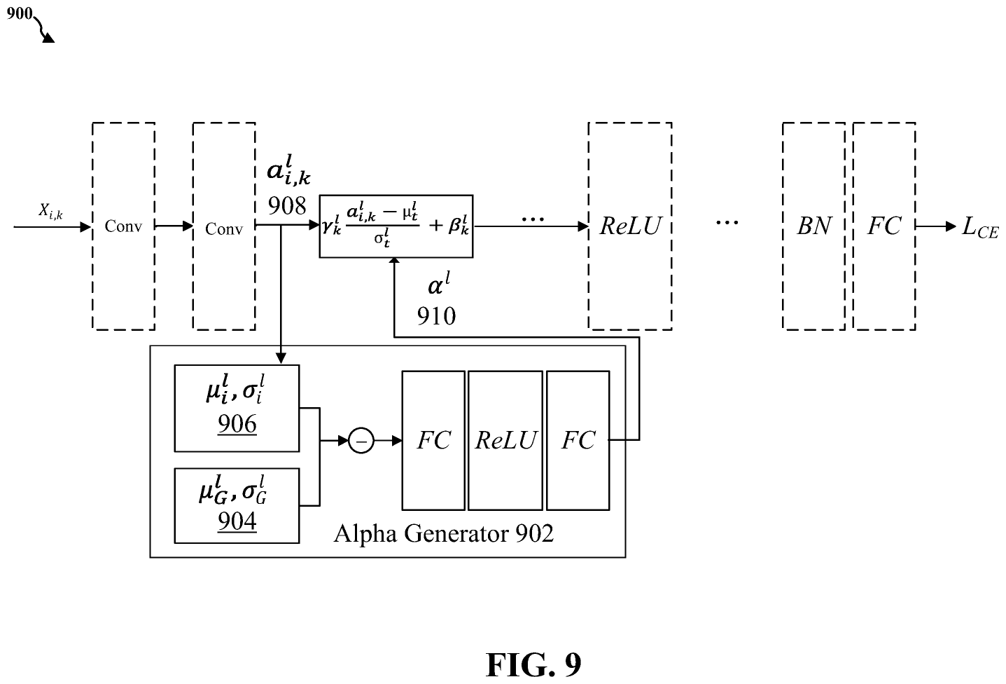

Upon deployment of the global model 720 to a federated client device 706 associated with a domain unknown to the federated server device 702, the federated client device 706 may employ the global model 720 to perform an ML task to generate inference information. In some aspects, the global model 720 may be unable to generalize to the domain of the federated client device 706 given that the domain is unknown to the federated server device 702. Further, the federated client device 706 cannot access the local batch normalization statistics of the federated client devices 704. As such, in some aspects, as illustrated in FIG. 9, during inference generation, the federated client device 706 may interpolate global batch normalization statistics 724 with instance test statistics 726. Further, the federated client device 706 may employ an alpha generator (e.g., a zero-shot adapter) to interpolate the global batch normalization statistics 724 with instance test statistics 726. In some aspects, the zero-shot adapter may be trained using federate learning as illustrated in FIG. 9.

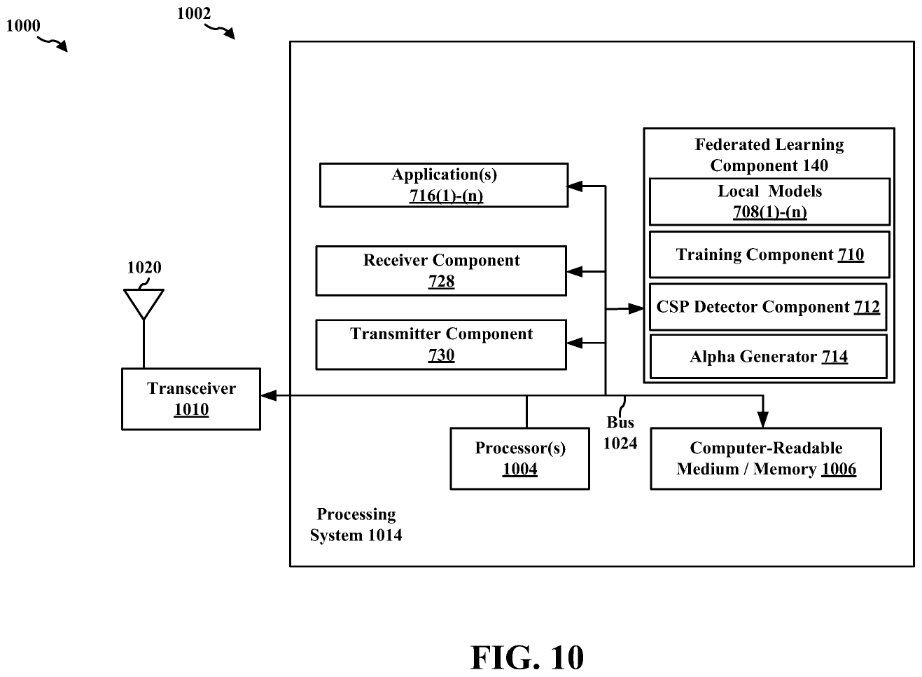

In addition, a federated client devices 704 and/or a federated client devices 706 may include a receiver component 728 and a transmitter component 730. The receiver component 728 may include, for example, a radio frequency (RF) receiver for receiving the signals described herein. The transmitter component 730 may include, for example, an RF transmitter for transmitting the signals described herein. In an aspect, the receiver component 728 and the transmitter component 730 may be co-located in a transceiver (e.g., the transceiver 1010 shown in FIG. 10).

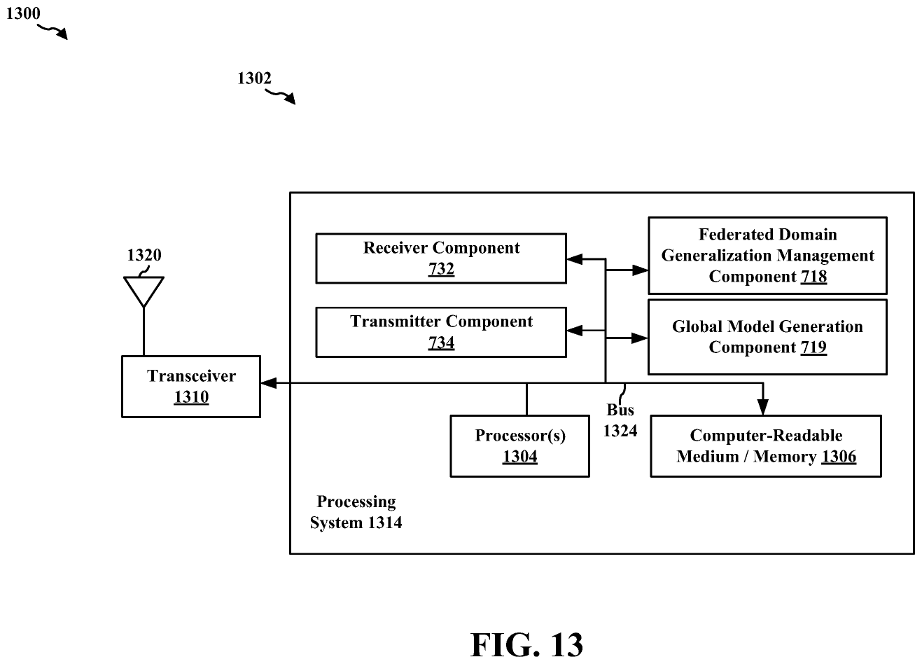

In addition, the federated server devices 706 may include a receiver component 732 and a transmitter component 734. The receiver component 732 may include, for example, a radio frequency (RF) receiver for receiving the signals described herein. The transmitter component 734 may include, for example, an RF transmitter for transmitting the signals described herein. In an aspect, the receiver component 732 and the transmitter component 734 may be co-located in a transceiver (e.g., the transceiver 1310 shown in FIG. 13).

FIG. 8 is a diagram 800 illustrating an example of client-agnostic learning with data augmentation, in accordance with some aspects of the present disclosure. As described herein, because each local model is trained in a different domain, each local model is fitted to its own specific domain, which may cause unsatisfactory performance by a global model generated by aggregating the CSP information associated with the different local models. Accordingly, as illustrated in FIG. 8, in some aspects, a training component (e.g., the training component 710) may configure a local model 802 (e.g., a local model 708) to augment local data with a data distribution from other federated client devices without any privacy leakage. In particular, the local model 802 may interpolate local BN statistics 804 (i.e., statistics of local samples) with mixed instance and global statistics (mixed statistics) 806 during training.

For example, let X and Y denote the input and label spaces, respectively. The k-th client in the federation has a single-domain data Dₖ={(x_{i,k}, Y_{i,k})}ᵢ₌₁ⁿ^{ₖ}, where nₖ is the number of samples. The set of distributed source domain data from K federated clients is represented as {D₁, . . . , Dₖ}. In federated domain generalization, there exists a domain shift across clients, where each client data Dₖ sampled from a domain specific distribution (Xₖ, Y) that differs from other clients. The target test domain data from an unseen environment is represented as Dₜ, with a distribution (Xₜ, Y) that is shifted from the training data. The feature extractor, parameterized by θ, is represented as F₆ (where F_{θ}_{ₖ} is the feature extractor for the k-th client), and the classifier, parameterized by ϕ, is represented as C_{ϕ} (where C_{ϕk} is the classifier for the for the k-th client). In some aspects, a federated system (e.g., the federated system 700) aims to learn a generalized global model C_{ϕG}∘F_{θ}_{_{G}}: X→Y by aggregating K distributed federated clients' models {F_{θ}_{ₖ}, C_{ϕ}_{ₖ}}ₖ₌₁^{K} trained on source data {Dₖ}ₖ₌₁^{K}, such that the global model generalizes to the unseen target domain Dₜ.

In local training, the k-th local model is trained with the cross-entropy loss function 808 on k-th dataset as follows:

$${L}_{CE} = \frac{1}{\vert {D}_{k} \vert} {\sum }_{i = 1}^{{n}_{k}} CE ( {C}_{{∅}_{k}} ( {F}_{{θ}_{k}} ( {X}_{i , k} ) ) , {y}_{i , k} ) \qquad ( Eq . 1 )$$

Before starting local training, the client receives the global model parameters {θ_{G}, ϕ_{G}} and initializes the local model {Bₖ, ϕₖ} with the global parameters. Then, F_{ϕ}_{ₖ} and C_{ϕ}_{ₖ} are trained on local data for long epochs. Although {θₖ, ϕₖ} is initialized with the global model, it may not solely rely on cross-entropy loss with single domain data to learn client-invariant representations, as direct use of data from other federated clients raises privacy concerns. To address this issue, in some aspects, the federated system generates diverse domains using the statistics in BN layers of the global model. For example, a training component may set all batch normalization layers in the backbone network as local BN layers:

$$BN = {γ}_{k}^{l} \frac{{a}_{k}^{l} - {μ}_{k}^{l}}{{σ}_{k}^{l}} + {β}_{k}^{l} \qquad ( Eq . 2 )$$

Where μₖ^{l} and σₖ^{l} are BN statistics of the l-th BN layer of the k-th client, which are calculated as running means and variances, aₖ^{l} indicates an input tensor of the k-th client, and γₖ^{l} and βₖ^{l} are learnable affine parameters.

As described herein, the local feature f_{i,k} is obtained by using batch normalization at the local client level, while the augmented feature f_{t,Δ} is obtained through a mixed instance and global statistics approach implemented by interpolating instance and global statistics in a randomized manner, which leads to the standardization of an intermediate feature a_{i,k}^{l} that can be a variety of features, as illustrated in FIG. 8. The process may be repeated at every BN layer. With these features, the local models are capable of learning client-invariant representations using equations 5 and 6.

The training component may mix the mean and standard deviation of each sample with global statistics {μ_{G}, σ_{G}} i.e., running mean and standard deviation, as follows:

u_{Δ}^{l}=u^{l}μᵢ^{l}+(1−u^{l})μ_{G}^{l} (Eq. 3)

σ_{Δ}^{l}=u^{l}σᵢ^{l}+(1−u^{l})σ_{G}^{l} (Eq. 4)

Where u_{Δ}^{l} and σ_{Δ}^{l} indicate instance mean and standard deviation along the channel axis of the intermediate feature of the i-th input of the l-th BN layer, respectively, u^{l}∈R^{C}^{^{l}} is an interpolation weight vector, where each element is independently sampled from uniform distribution U(0, 1) and C^{l} is the feature dimension in the l-th BN layer.

In some aspects, the feature normalized by instance statistics contains local representative characteristics, while the feature normalized using global statistics consists of global representations. By randomly interpolating these two statistics in all BN layers, a federated system can obtain more diverse data by leveraging the characteristics of both local and global domains.

Further, the augmented feature f_{Δ} is normalized by the interpolated statistics, and the training component may train the local model 802 using f_{Δ} in a client-agnostic form. Additionally, as illustrated in FIG. 8, the local model 802 may generate client-agnostic feature loss 810. Client-agnostic feature loss 810 may be determined as follows:

$${L}_{CAFL} = \frac{1}{\vert {D}_{k} \vert} {\sum }_{i = 1}^{{n}_{k}} {‖ {f}_{i , k} - {f}_{i , Δ} ‖}_{2}^{2} \qquad ( Eq . 5 )$$

By employing the loss function of the client-agnostic feature loss 810, the local model 802 can extract the client-agnostic features by minimizing the distance between the original and augmented features.

In addition, the training component may train the local classifier to classify the features from other domains such that the local classifier can be the client-agnostic classifier. In order to become a client-agnostic classifier, the local classifier (C_{ϕ}_{ₖ}) is trained with a client-agnostic classification loss function 812 as follows:

$${L}_{CACL} = \frac{1}{\vert {D}_{k} \vert} {\sum }_{i = 1}^{{n}_{k}} CE ( {C}_{{ϕ}_{k}} ( {f}_{i , Δ} ) , {y}_{i , k} ) \qquad ( Eq . 6 )$$

Where L_{CE} is cross entropy loss 808, F_{θk,c} is the classifier of k-th client and the classifier is updated with this loss function. In some aspects, the client-agnostic learning performed by the training component can be considered as a regularization method that forces the local model not diverging with the global model. Further, the overall loss for local optimization is as follows:

Lₜₒₜₐₗ=(1−λ₁)·L_{CE}+λ₁·L_{CACL}+λ₂·L_{CAFL} (Eq. 7)

FIG. 9 is a diagram 900 illustrating an example of an alpha generator 902 (e.g., a zero-shot adapter), in accordance with some aspects of the present disclosure. As described herein, a global model generated using aggregated CSP information (e.g., the CSP information 616) may be unable to satisfactorily generalize to a domain (e.g., the federated client device 706) unknown to the federated server (e.g., the federated server device 702). Accordingly, in some aspects, a federated client device employing a global model may dynamically use instance statistics with global BN statistics fully reflecting test distribution during inference to generalize the global model received from a federated server device when the domain of the federated client device is unknown to the federated server device. For example, as illustrated in FIG. 9, the federated client device may interpolate running means and variances 904 in BN layers with statistics 906 of the test input as follows:

μₜ^{l}=α^{l}μᵢ^{l}+(1−α^{l})μ_{G}^{l} (Eq. 6)

σₜ^{l}=α^{l}σᵢ^{l}+(1−α^{l})σ_{G}^{l} (Eq. 7)

Where μᵢ^{l} and σᵢ^{l} indicate instance mean and variance of the input tensor in the l-th BN layer, μₜ^{l} and σₜ^{l} are used for normalizing the test input tensor, and α^{l} is an interpolation parameter that adjusts the contribution of instance statistics of the test sample. In some aspects, a is selected to test domains or test inputs, e.g., the fixed values for the specific test domain or dynamic values for a test input. However, in some aspects, the federated client may be unable to select the proper α, and search space for α is very large, where a is within [0, 1] and each αₗ might be different with α in other layers. Accordingly, a federated client device may employ an alpha generator 902, which is configured to generate a for each input in both known and unknown domains.

For example, as illustrated in FIG. 9, the alpha generator 902 may be added to batch normalization layers of a global model. Further, the input 908 to the alpha generator 902 may be the channel-wise distance between instance and global statistics {μᵢ^{l}−μ_{G}^{l}, σᵢ^{l}−σ_{G}^{l}}∈R^{2C}^{^{l}}. The output 910 may be a^{l}. In some aspects, a^{l} is set to a scalar value to interpolate instance and global statistics with the same weights along the channel axis in the l-th BN layer, which reduces the network size of the zero-shot adapter and mitigates overfitting to the local data.

In some aspects, a training component (e.g., the training component 710) may train the alpha generator 902 by simulating test scenarios in the federated learning stage that forward training samples to the main network, F_{ϕ}_{ₖ} and C_{ϕ}_{ₖ}, where BN statistics are replaced with the interpolated BN statistics in equations 6 and 7. Further, the alpha generator 902 is updated with cross-entropy loss to generate the optimal interpolation parameters, a^{l}, based on the difference between instance and global statistics. In some aspects, the training procedure for the alpha generator 902 may not affect the performance of the main network since its purpose is only to learn how to interpolate instance and global statistics for minimizing the cross-entropy loss on the trained main network. Therefore, the main network and the alpha generator 902 are alternately trained, freezing the other model. For example, when the alpha generator 902 is being trained, the FC layer(s) and ReLU layer(s) of the alpha generator 902 are being updated while the convolutional layer(s), ReLU layer(s), BN layer(s), and FC layer(s) of the main network are frozen. To prevent overfitting of the adapter to each training domain, the training component may apply a reparameterization method. For example, the interpolation parameters may be generated by sampling from the gaussian distribution, re-parameterized by the adapter as follows: a^{l}=T(δ^{l}z^{l}+ϵ^{l}), where δ^{l},ϵ^{l}=_{φ}_{^{l}}({μᵢ^{l}−μ_{G}^{l},σᵢ^{l}−σ_{G}^{l}}), and z^{l} is sampled from N(0, 1). In some aspects, T(·) is a clamp function to ensure a^{l} is within the range of [0,1].

During the inference phase, a^{l} is parameterized as ϵ^{l}, which is the expected value of δ^{l}z^{l}+ϵ^{l}. Further, the normalization of the test input may be performed using the interpolated statistics through {μᵢ^{l},σᵢ^{l}}ᵢ₌₁^{L} in equations 6 and 7 at every BN layer, which is conducted via single forward propagation.

FIG. 10 is a diagram 1000 illustrating an example of a hardware implementation for a federated client device 1002 (e.g., the UE 104, the federated client device 606, the federated client device 704, the federated client device 706) employing a processing system 1014. The processing system 1014 may be implemented with a bus architecture, represented generally by the bus 1024. The bus 1024 may include any number of interconnecting buses and/or bridges depending on the specific application of the processing system 1014 and the overall design constraints. The bus 1024 links together various circuits including one or more processors and/or hardware components, represented by the processor(s) 1004, the one or more local models 708(1)-(n), the federated learning component 140, the training component 710, the CSP detector component 712, the alpha generator 714, the one or more applications 716(1)-(n), and the computer-readable medium (e.g., non-transitory computer-readable medium)/memory 1006. The bus 1024 may also link various other circuits such as timing sources, peripherals, voltage regulators, and power management circuits, which are well known in the art, and therefore, will not be described any further.

The processing system 1014 may be coupled with a transceiver 1010. The transceiver 1010 may be coupled with one or more antennas 1020. The transceiver 1010 provides a means for communicating with various other apparatus over a transmission medium. The transceiver 1010 receives a signal from the one or more antennas, extracts information from the received signal, and provides the extracted information to the processing system 1014, specifically the receiver component 728. The receiver component 728 may receive the federated information 608 and the global model 720. In addition, the transceiver 1010 receives information from the processing system 1014, specifically the transmitter component 730, and based on the received information, generates a signal to be applied to the one or more antennas. Further, the transmitter component 730 may send the CSP information 616 and/or the CSP information 722.

The processing system 1014 includes a processor(s) 1004 coupled with a computer-readable medium/memory 1006 (e.g., a non-transitory computer readable medium). The processor(s) 1004 is responsible for general processing, including the execution of software stored on the computer-readable medium/memory 1006. The software, when executed by the processor(s) 1004, causes the processing system 1014 to perform the various functions described supra for any particular apparatus. The computer-readable medium/memory 1006 may also be used for storing data that is manipulated by the processor(s) 1004 when executing software. The processing system 1014 further includes the one or more local models 708(1)-(n), the federated learning component 140, the training component 710, the CSP detector component 712, the alpha generator 714, and the one or more applications 716(1)-(n). The aforementioned components may be a software component running in the processor(s) 1004, resident/stored in the computer readable medium/memory 1006, one or more hardware components coupled with the processor(s) 1004, or some combination thereof. The processing system 1014 may be a component of the federated client device 1002 and may include the memory 360 and/or at least one of the TX processor 368, the RX processor 356, and the controller/processor 359. Alternatively, the processing system 1014 may be the entire federated client device (e.g., see 350 of FIG. 3, the federated client device 606 of FIG. 6, the federated client device 704 of FIG. 7, the federated client device 706 of FIG. 7).

The aforementioned means may be one or more of the aforementioned components of the federated client device 1002 and/or the processing system 1014 of federated client device 1002 configured to perform the functions recited by the aforementioned means. As described supra, the processing system 1014 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

Referring to FIGS. 1-11, in operation, federated client device 1002 may perform a method 1100 of wireless communication. The method may be performed by the entire federated client device, or a component of the federated client device, e.g., the parameter set management component 140/510 by the processor(s) 1004, the computer-readable medium/memory 1006, TX processor 368, the RX processor 356, and/or the controller/processor 359.

At block 1102, the method 1100 includes identifying client invariant information of a neural network for performing a machine learning (ML) task in a first domain known to a federated server. For example, in some aspects, at least one of the federated client device 606, the federated client device 704, the federated client device 706, the local model 708, the local model 802, the processor(s) 1004, the computer-readable medium/memory 1006, CSP detector component 712 may be configured to or may comprise means for identifying client invariant information of a neural network for performing a machine learning (ML) task in a first domain known to a federated server. For example, the CSP detector component 712 may detect the client invariant layers of the local model 708. In some aspects, the CSP detector component 712 may identify the client invariant layers of the local model 708 based on batch normalization information of the local model 708. For example, the CSP detector component 712 may identify the batch normalization layers of the local model 708 as the client variant layers and the remaining layers as the client invariant information.

At block 1104, the method 1100 includes transmitting the client invariant information to the federated server. The federated server may be configured to generate a ML model for performing the ML task in a domain unknown to the federated server based on the client invariant information and other client invariant information of another neural network for performing the ML task in a second domain known to the federated server. For example, in some aspects, at least one of the federated client device 1002, the federated client device 606, the federated client device 704, the federated client device 706, the CSP detector component, the processor(s) 1004, the computer-readable medium/memory 1006, and/or transmitter component 534 may be configured to or may comprise means for transmitting the client invariant information to the federated server, the federated server configured to generate a ML model for performing the ML task in a domain unknown to the federated server based on the client invariant information and other client invariant information of another neural network for performing the ML task in a second domain known to the federated server. For example, the federated client device 1002 may transmit the transmit the client invariant information layers to the federated server device 702 as CSP information 722.

Referring to FIGS. 1-12, in operation, federated client device 1002 may perform a method 1200 of wireless communication. The method may be performed by the entire federated client device, or a component of the federated client device, e.g., the parameter set management component 140/510 by the processor(s) 1004, the computer-readable medium/memory 1006, TX processor 368, the RX processor 356, and/or the controller/processor 359.

At block 1202, the method 1200 includes receiving, from a federated server, a neural network for performing a machine learning task. The neural network may have been generated by the federated server using a plurality of client invariant information received from a plurality of other neural networks associated with one or more domains known to the federated server. For example, in some aspects, at least one of the federated client device 606, the federated client device 704, the federated client device 706, the processor(s) 1004, the computer-readable medium/memory 1006, the training component 710, and/or receiver component 728 may be configured to or may comprise means for receiving, from a federated server, a neural network for performing a machine learning task, the neural network generated by the federated server using a plurality of client invariant information received from a plurality of other neural networks associated with one or more domains known to the federated server. For example, the federated client device 706 may receive the global model 720 from the federated server device 702. As described herein, the federated server device 702 may generate the global model 720 from the CSP information 722 received from the plurality of federated client devices 704 associated with domains known to the federated server device 702.

At block 1204, the method 1200 includes generating, via the neural network, inference information in a domain unknown to the federated server based on an alpha generator added to a batch normalization layer of the neural network. For example, in some aspects, at least one of the federated client device 1002, the federated client device 606, the federated client device 704, the federated client device 706, the local model 708, the global model 720, the alpha generator 714, the processor(s) 1004, and/or the computer-readable medium/memory 1006 may be configured to or may comprise means for generating, via the neural network, inference information in a domain unknown to the federated server based on an alpha generator added to a batch normalization layer of the neural network. For example, upon deployment of the global model 720 to a federated client device 706 associated with a domain unknown to the federated server device 702, the federated client device 706 may employ the global model 720 to determine perform a ML task to generate inference information. Further, the federated client device 706 may employ the alpha generator 902 (e.g., a zero-shot adapter) to interpolate global batch normalization statistics 724 with instance test statistics 726 during generation of the inference information.

FIG. 13 is a diagram 1300 illustrating an example of a hardware implementation for a federated server device 1302 employing a processing system 1314. The processing system 1314 may be implemented with a bus architecture, represented generally by the bus 1324. The bus 1324 may include any number of interconnecting buses and bridges depending on the specific application of the processing system 1314 and the overall design constraints. The bus 1324 links together various circuits including one or more processors and/or hardware components, represented by the processor(s) 1304, the federated domain generalization management component 718, the global model generation component 719, and the computer-readable medium/memory 1306. The bus 1324 may also link various other circuits such as timing sources, peripherals, voltage regulators, and power management circuits, which are well known in the art, and therefore, will not be described any further.

The processing system 1314 may be coupled with a transceiver 1310. The transceiver 1310 is coupled with one or more antennas 1320. The transceiver 1310 provides a means for communicating with various other apparatus over a transmission medium. The transceiver 1310 receives a signal from the one or more antennas 1320, extracts information from the received signal, and provides the extracted information to the processing system 1314, specifically the receiver component 732. The receiver component 732 may receive the CSP information 616 and the CSP information 722(1)-(n). In addition, the transceiver 1310 receives information from the processing system 1314, specifically the transmitter component 734, and based on the received information, generates a signal to be applied to the one or more antennas 1320. Further, the transmitter component 734 may send the federated information 608 and the global model 720.

The processing system 1314 includes a processor(s) 1304 coupled with a computer-readable medium/memory 1306 (e.g., a non-transitory computer readable medium). The processor(s) 1304 is responsible for general processing, including the execution of software stored on the computer-readable medium/memory 1306. The software, when executed by the processor(s) 1304, causes the processing system 1314 to perform the various functions described supra for any particular apparatus. The computer-readable medium/memory 1306 may also be used for storing data that is manipulated by the processor(s) 1304 when executing software. The processing system 1314 further includes the federated domain generalization management component 718 and the global model generation component 719. The aforementioned components may be software components running in the processor(s) 1304, resident/stored in the computer readable medium/memory 1306, one or more hardware components coupled with the processor(s) 1304, or some combination thereof. The processing system 1314 may be a component of the base station 313 and may include the memory 376 and/or at least one of the TX processor 316, the RX processor 370, and the controller/processor 375. Alternatively, the processing system 1314 may be the entire base station (e.g., see 310 of FIG. 3, the federated server device 602 of FIG. 6, the federated server device 702 of FIG. 7).

The aforementioned means may be one or more of the aforementioned components of the federated server device 1302 and/or the processing system 1314 of the federated server device 1302 configured to perform the functions recited by the aforementioned means. As described supra, the processing system 1314 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

### EXAMPLE CLAUSES

Clause 1. A federated client device, comprising: one or more memories storing computer-executable instructions; and one or more processors coupled with the one or more memories and configured to execute the computer-executable instructions, individually or in combination, to cause the federated client device to: identify client invariant information of a neural network for performing a machine learning (ML) task in a first domain known to a federated server; and transmit the client invariant information to the federated server, the federated server configured to generate a ML model for performing the ML task in a domain unknown to the federated server based on the client invariant information and other client invariant information of another neural network for performing the ML task in a second domain known to the federated server.
Clause 2. The federated client device of clause 1, wherein the one or more processors, individually or in combination, are further configured to cause the federated client device to: receive federated ML information from the federated server; and generate the neural network based on the federated ML information.
Clause 3. The federated client device of any of clauses 1-3, wherein the client invariant information comprises at least one of a weight, a gradient, or a scaling factor, the scaling factor being a multiplicand or a summand.
Clause 4. The federated client device of any of clauses 1-4, wherein to identify the client invariant information of the neural network, the one or more processors, individually or in combination, are configured to: select invariant layers of the neural network that are not batch normalization layers of the neural network as the client invariant information.
Clause 5. The federated client device of any of clauses 1-5, wherein the one or more processors, individually or in combination, are further configured to cause the federated client device to: train the neural network by interpolating instance statistics of sample data and global statistics associated with a plurality of other federated client devices.
Clause 6. The federated client device of clause 5, wherein the global statistics include batch normalization statistics collected from the plurality of other federated client devices.
Clause 7. The federated client device of clause 6, wherein to train the neural network, the one or more processors, individually or in combination, are configured to: train the neural network by interpolating a mean and a variance of the instance statistics with a mean and a variance of the batch normalization statistics.
Clause 8. The federated client device of any of clauses 1-7, wherein the federated server is a first federated server, the ML task is a first ML task, the neural network is a first neural network, and the one or more processors, individually or in combination, are configured to cause the federated client device to: receive federated ML information from a second federated server, the federated ML information including a second neural network generated by the second federated server for performing a second ML task and generated by the second federated server using a plurality of client invariant information of a plurality of other neural networks for performing the second ML task in a plurality of domains known to the second federated server; and generate, via the second neural network, inference information in a domain unknown to the second federated server based on an alpha generator added to a batch normalization layer of the second neural network.
Clause 9. The federated client device of clause 8, wherein the alpha generator is a zero-shot adapter, and to determine the inference information, the one or more processors, individually or in combination, are configured to cause the federated client device to: interpolate, via the zero-shot adapter, global batch normalization statistics with instance test statistics at the batch normalization layer to generate a learning parameter based on a channel-wise distance between the global batch normalization statistics and instance test statistics.
Clause 10. The federated client device of clause 9, wherein the at least one processor is further configured to train the zero-shot adapter via federated learning.
Clause 11. The federated client device of clause 9, wherein the plurality of client invariant information corresponds to layers of the plurality of other neural networks that are not batch normalization layers.
Clause 12. A method comprising: identifying client invariant information of a neural network for performing a machine learning (ML) task in a first domain known to a federated server; and transmitting the client invariant information to the federated server, the federated server configured to generate a ML model for performing the ML task in a domain unknown to the federated server based on the client invariant information and other client invariant information of another neural network for performing the ML task in a second domain known to the federated server.
Clause 13. The method of clause 12, further comprising: receiving federated ML information from the federated server; and generating the neural network based on the federated ML information.
Clause 14. The method of any of clauses 12-13, wherein the client invariant information comprises at least one of a weight, a gradient, or a scaling factor, the scaling factor being a multiplicand or a summand.
Clause 15. The method of any of clauses 12-14, wherein identifying the client invariant information of the neural network comprises selecting invariant layers of the neural network that are not batch normalization layers of the neural network as the client invariant information.
Clause 16. The method of any of clauses 12-15, further comprising training the neural network by interpolating instance statistics of sample data and global statistics associated with a plurality of other federated client devices.
Clause 17. The method of clause 16, wherein the global statistics include batch normalization statistics collected from the plurality of other federated client devices.
Clause 18. The method of clause 17, wherein training the neural network comprises training the neural network by interpolating a mean and a variance of the instance statistics with a mean and a variance of the batch normalization statistics.
Clause 19. The method of any of clauses 12-18, wherein the federated server is a first federated server, the ML task is a first ML task, the neural network is a first neural network, and further comprising: receiving federated ML information from a second federated server, the federated ML information including a second neural network generated by the second federated server for performing a second ML task and generated by the second federated server using a plurality of client invariant information of a plurality of other neural networks for performing the second ML task in a plurality of domains known to the second federated server; and generating, via the second neural network, inference information in a domain unknown to the second federated server based on an alpha generator added to a batch normalization layer of the second neural network.
Clause 20. The method of clause 19, wherein the alpha generator is a zero-shot adapter, and determining the inference information, comprises: interpolating, via the zero-shot adapter, global batch normalization statistics with instance test statistics at the batch normalization layer to generate a learning parameter based on a channel-wise distance between the global batch normalization statistics and instance test statistics.
Clause 21. The method of clause 20, further comprising training the zero-shot adapter via federated learning.
Clause 22. The method of clause 20, wherein the plurality of client invariant information corresponds to layers of the plurality of other neural networks that are not batch normalization layers.
Clause 23. A federated client device, comprising: one or more memories storing computer-executable instructions; and one or more processors coupled with the one or more memories and configured to execute the computer-executable instructions, individually or in combination, to cause the federated client device to: receive, from a federated server, a neural network for performing a machine learning task, the neural network generated by the federated server using a plurality of client invariant information received from a plurality of other neural networks associated with one or more domains known to the federated server; and generate, via the neural network, inference information in a domain unknown to the federated server based on an alpha generator added to a batch normalization layer of the neural network.
Clause 24. The federated client device of clause 23, wherein the alpha generator is a zero-shot adapter, and to determine the inference information, the one or more processors, individually or in combination, are configured to: interpolate, via the zero-shot adapter, global batch normalization statistics with instance test statistics at the batch normalization layer to generate a learning parameter based on a channel-wise distance between the global batch normalization statistics and the instance test statistics.
Clause 25. The federated client device of clause 24, wherein the one or more processors, individually or in combination, are further configured to cause the federated client device to train the zero-shot adapter via federated learning.
Clause 26. The federated client device of any of clauses 23-25, wherein the plurality of client invariant information corresponds to layers of the plurality of other neural networks that are not batch normalization layers.
Clause 27. A method comprising: receiving, from a federated server, a neural network for performing a machine learning task, the neural network generated by the federated server using a plurality of client invariant information received from a plurality of other neural networks associated with one or more domains known to the federated server; and generating, via the neural network, inference information in a domain unknown to the federated server based on an alpha generator added to a batch normalization layer of the neural network.
Clause 28. The method of clause 27, wherein the alpha generator is a zero-shot adapter, and determining the inference information, comprises: interpolating, via the zero-shot adapter, global batch normalization statistics with instance test statistics at the batch normalization layer to generate a learning parameter based on a channel-wise distance between the global batch normalization statistics and the instance test statistics.
Clause 29. The method of clause 28, further comprising training the zero-shot adapter via federated learning.
Clause 30. The method of any of clauses 27-29, wherein the plurality of client invariant information corresponds to layers of the plurality of other neural networks that are not batch normalization layers.

The previous description is provided to enable any person having ordinary skill in the art to practice the various aspects described herein. Various modifications to these aspects will be readily apparent to a person having ordinary skill in the art, and the generic principles defined herein may be applied to other aspects. The claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to a person having ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A federated client device, comprising:
one or more memories storing computer-executable instructions; and
one or more processors coupled with the one or more memories and configured to execute the computer-executable instructions, individually or in combination, to cause the federated client device to:
identify client invariant information of a neural network for performing a machine learning (ML) task in a first domain known to a federated server; and
transmit the client invariant information to the federated server, the federated server configured to generate a ML model for performing the ML task in a domain unknown to the federated server based on the client invariant information and other client invariant information of another neural network for performing the ML task in a second domain known to the federated server.

2. The federated client device of claim 1, wherein the one or more processors, individually or in combination, are further configured to cause the federated client device to:
receive federated ML information from the federated server; and
generate the neural network based on the federated ML information.

3. The federated client device of claim 1, wherein the client invariant information comprises at least one of a weight, a gradient, or a scaling factor, the scaling factor being a multiplicand or a summand.

4. The federated client device of claim 1, wherein to identify the client invariant information of the neural network, the one or more processors, individually or in combination, are configured to:
select invariant layers of the neural network that are not batch normalization layers of the neural network as the client invariant information.

5. The federated client device of claim 1, wherein the one or more processors, individually or in combination, are further configured to cause the federated client device to:
train the neural network by interpolating instance statistics of sample data and global statistics associated with a plurality of other federated client devices.

6. The federated client device of claim 5, wherein the global statistics include batch normalization statistics collected from the plurality of other federated client devices.

7. The federated client device of claim 6, wherein to train the neural network, the one or more processors, individually or in combination, are configured to:
train the neural network by interpolating a mean and a variance of the instance statistics with a mean and a variance of the batch normalization statistics.

8. The federated client device of claim 1, wherein the federated server is a first federated server, the ML task is a first ML task, the neural network is a first neural network, and the one or more processors, individually or in combination, are configured to cause the federated client device to:
receive federated ML information from a second federated server, the federated ML information including a second neural network generated by the second federated server for performing a second ML task and generated by the second federated server using a plurality of client invariant information of a plurality of other neural networks for performing the second ML task in a plurality of domains known to the second federated server; and
generate, via the second neural network, inference information in a domain unknown to the second federated server based on an alpha generator added to a batch normalization layer of the second neural network.

9. The federated client device of claim 8, wherein the alpha generator is a zero-shot adapter, and to determine the inference information, the one or more processors, individually or in combination, are configured to cause the federated client device to:
interpolate, via the zero-shot adapter, global batch normalization statistics with instance test statistics at the batch normalization layer to generate a learning parameter based on a channel-wise distance between the global batch normalization statistics and instance test statistics.

10. The federated client device of claim 9, wherein the at least one processor is further configured to train the zero-shot adapter via federated learning.

11. The federated client device of claim 9, wherein the plurality of client invariant information corresponds to layers of the plurality of other neural networks that are not batch normalization layers.

12. A method comprising:
identifying client invariant information of a neural network for performing a machine learning (ML) task in a first domain known to a federated server; and
transmitting the client invariant information to the federated server, the federated server configured to generate a ML model for performing the ML task in a domain unknown to the federated server based on the client invariant information and other client invariant information of another neural network for performing the ML task in a second domain known to the federated server.

13. The method of claim 12, further comprising:
receiving federated ML information from the federated server; and
generating the neural network based on the federated ML information.

14. The method of claim 12, wherein the client invariant information comprises at least one of a weight, a gradient, or a scaling factor, the scaling factor being a multiplicand or a summand.

15. The method of claim 12, wherein identifying the client invariant information of the neural network comprises selecting invariant layers of the neural network that are not batch normalization layers of the neural network as the client invariant information.

16. The method of claim 12, further comprising training the neural network by interpolating instance statistics of sample data and global statistics associated with a plurality of other federated client devices.

17. The method of claim 16, wherein the global statistics include batch normalization statistics collected from the plurality of other federated client devices.

18. The method of claim 17, wherein training the neural network comprises training the neural network by interpolating a mean and a variance of the instance statistics with a mean and a variance of the batch normalization statistics.

19. The method of claim 12, wherein the federated server is a first federated server, the ML task is a first ML task, the neural network is a first neural network, and further comprising:
receiving federated ML information from a second federated server, the federated ML information including a second neural network generated by the second federated server for performing a second ML task and generated by the second federated server using a plurality of client invariant information of a plurality of other neural networks for performing the second ML task in a plurality of domains known to the second federated server; and
generating, via the second neural network, inference information in a domain unknown to the second federated server based on an alpha generator added to a batch normalization layer of the second neural network.

20. The method of claim 19, wherein the alpha generator is a zero-shot adapter, and determining the inference information, comprises:
interpolating, via the zero-shot adapter, global batch normalization statistics with instance test statistics at the batch normalization layer to generate a learning parameter based on a channel-wise distance between the global batch normalization statistics and instance test statistics.

21. The method of claim 20, further comprising training the zero-shot adapter via federated learning.

22. The method of claim 20, wherein the plurality of client invariant information corresponds to layers of the plurality of other neural networks that are not batch normalization layers.

23. A federated client device, comprising:
one or more memories storing computer-executable instructions; and
one or more processors coupled with the one or more memories and configured to execute the computer-executable instructions, individually or in combination, to cause the federated client device to:
receive, from a federated server, a neural network for performing a machine learning task, the neural network generated by the federated server using a plurality of client invariant information received from a plurality of other neural networks associated with one or more domains known to the federated server; and
generate, via the neural network, inference information in a domain unknown to the federated server based on an alpha generator added to a batch normalization layer of the neural network.

24. The federated client device of claim 23, wherein the alpha generator is a zero-shot adapter, and to determine the inference information, the one or more processors, individually or in combination, are configured to:
interpolate, via the zero-shot adapter, global batch normalization statistics with instance test statistics at the batch normalization layer to generate a learning parameter based on a channel-wise distance between the global batch normalization statistics and the instance test statistics.

25. The federated client device of claim 24, wherein the one or more processors, individually or in combination, are further configured to cause the federated client device to train the zero-shot adapter via federated learning.

26. The federated client device of claim 23, wherein the plurality of client invariant information corresponds to layers of the plurality of other neural networks that are not batch normalization layers.

27. A method comprising:
receiving, from a federated server, a neural network for performing a machine learning task, the neural network generated by the federated server using a plurality of client invariant information received from a plurality of other neural networks associated with one or more domains known to the federated server; and
generating, via the neural network, inference information in a domain unknown to the federated server based on an alpha generator added to a batch normalization layer of the neural network.

28. The method of claim 27, wherein the alpha generator is a zero-shot adapter, and determining the inference information, comprises:
interpolating, via the zero-shot adapter, global batch normalization statistics with instance test statistics at the batch normalization layer to generate a learning parameter based on a channel-wise distance between the global batch normalization statistics and the instance test statistics.

29. The method of claim 28, further comprising training the zero-shot adapter via federated learning.

30. The method of claim 27, wherein the plurality of client invariant information corresponds to layers of the plurality of other neural networks that are not batch normalization layers.
